(19) United States
(12) Patent Application Publication
(10) Pub. No.: US 2008/0175475 A1
(43) Pub. Date: Jul. 24, 2008

(54) Method of image frame compression

(76) Inventor: Chih-Ta Star Sung, Glonn (DE)

Correspondence Address: Chih-Ta Star Sung, Rm. 308, Bld. 52, No. 195, Sec. 4, Chung Hsin Rd., Juhdong, 310, omitted

(21) Appl. No.: 11/656,399

(22) Filed: Jan. 23, 2007

(51) Int. Cl. G06K 9/36; G06K 9/34

(52) U.S. Cl. 382/173; 382/244

(57) ABSTRACT

An image frame is compressed segment by segment by applying a lossless compression algorithm to the segment of pixels with simple pattern and a lossy algorithm to the segment with complex pattern. A segment comprising at least one homogenous area and one complex area will be compressed separately by assigning a lossless compression algorithm to compress the homogenous area and a lossly algorithm to compress the complex area. Another mechanism of partitioning a segment into multiple sub-segments with each sub-segment being compressed by one compression algorithm also helps in reducing the error in the homogenous area.

### BACKGROUND OF THE INVENTION

1. Field of Invention

The present invention relates to digital image frame compression, and, more specifically to an efficient image compression method that compresses image with mixture of homogenous area and complicated patterns in the neighboring location and results in good image quality.

2. Description of Related Art

The digital image and motion video have been adopted in an increasing number of applications, which include digital camera, scanner/printer/fax machine, video telephony, videoconferencing, 3G mobile phone, DVD, digital TV . . . etc. The success of development of the digital image and video compression standards including JPEG, a still image compression standard set by ITU and the MPEG, the motion video compression standard set by the ISO have played key role for the digital image and video applications. Both JPEG and MPEG are lossy algorithms which when being decompressed, the image data are different from the original ones. And the bit rate of each image frame is variable depending on the complexity of the image pattern.

In the television, DVD, STB, Set-Top-Box, 3G mobile phone or other portable devices, a decompressed video stream image will be temporarily saved into a storage device for other manipulation including scaling and de-interlacing before being sent to a display device. In these kind of applications, a fixed bit rate of compressed image is expected for convenience of allocating fixed density of the storage device or/and allocating fixed bandwidth of accessing the storage device during a pre-scheduled time slot.

Fixed bit rate of a compressed image frame provides necessary performance of random accessing pixels of any area with a fixed density of storage device which results in the saving of cost and power consumption. Since these image frames temporarily saved in the storage device will be used as references in the further image frames, keeping good quality is required. In some prior art compression algorithms including JPEG, MPEG and truncation, the loss of image quality might not be acceptable in some applications, especially when simple patterns and complicated patterns are shown in the neighboring location, though one can hardly visually tell the artifact in the region with complicated patterns, the error in the region with simple patterns, or said homogenous area can easily distinguished even a little error of said, 2 bits.

This present invention reduces the bit rate of an image frame while still keeps good image quality not only for images with complicated patterns or simple patterns, but also for images with mixture of simple and complicated pattern in the neighboring location.

### SUMMARY OF THE INVENTION

The present invention is related to a method of compressing an image frame which reduces the memory density, speeds up the procedure of accessing the image frame buffer with less power consumption. The present invention detects the complexity of each segment of pixels and compresses the groups of pixels and results in higher image quality.

The present invention of this efficient of image buffer compression detects the complexity of each segment of pixels and partitions one segment of pixels into multiple sub-segments for compression.

The present invention applies variable image compression algorithms into each sub-segment of pixels and compresses each sub-segment separately.

According to one embodiment of the present invention, a lossless coding algorithm is applied to the sub-segment with simple pattern and a lossy coding algorithm is applied to the sub-segment with complex pattern.

According to one embodiment of the present invention, a predetermined bit rate is assigned to identify the starting point of the homogenous area and another predetermined length of bits is reserved to indicate the length of homogenous area.

According to one embodiment of the present invention, a DCT is applied to transform the time domain pixels into frequency domain for the sub-segment of pixels with complex pattern.

According to one embodiment of the present invention, a predetermined length of bit is applied to reduce data rate for the sub-segment of pixels with complex pattern.

According to another embodiment of the present invention, a shorter code is applied to represent “End of Segment” (EOS) and another shorter code is applied to represent “Begin of Segment” for the starting point.

According to another embodiment of the present invention, a segment could be partitioned into two or four smaller segment with fewer amount of pixels each segment.

It is to be understood that both the foregoing general description and the following detailed description are by examples, and are intended to provide further explanation of the invention as claimed.

### BRIEF DESCRIPTION OF THE DRAWINGS

FIG. 1 shows basic segment by segment compression mechanism which has input pixels coming line by line.

FIG. 2 depicts a prior art compression method with a lossless compression plus a lossy coding algorithms.

FIG. 3 illustrates the common problem of compressing a group of pixels with part of them having simple pattern and part of them having complicated pattern and error worsening the area with simple pattern.

FIG. 4 depicts the concept of separating the homogenous area and complex area and compressing them individually.

FIG. 5 depicts this invention of separately compressing the homogenous area and complex area with variable compression algorithms.

FIG. 6 depicts the procedure of another compression mechanism of partitioning a group of pixels into smaller group of pixels and compressing separately.

### DESCRIPTION OF THE PREFERRED EMBODIMENTS

The decompressed image generated from a MEPG/JEPG decoder or the captured images might be saved in a temporary buffer for future display or other manipulations which could result in high requirement of storage density. For reducing the requirement of density and accessing time, compression is one of efficient ways to achieve the goal. Most compression algorithms reach the goal of data rate reduction with more or less image quality degradation. Some compression algorithms reach good image quality under a predetermined data rate, but bad quality for images with mixture of homogenous area and complicated patterns in neighboring location.

This invention of the image frame compression reduces the bit rate of the image frame under a predetermined data rate and still keeps good image quality for images with mixture of homogenous area and complicated patterns in neighboring location.

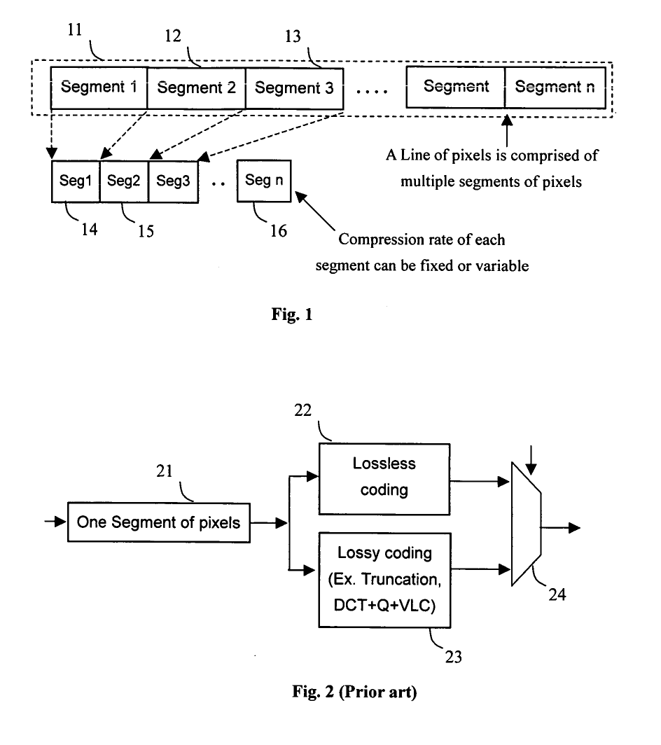

In compressing an image frame, an image 11 is partitioned into a numbers of “lines” of pixels and each line 11 of pixels is comprised of multiple “segments” 12, 13 of pixels as shown in FIG. 1. Each segment of pixels can be compressed with fixed bit rate for instance, a 2.0X compression rate and comes out of a fixed length of bits of each segment 14, 15, 16, and together forms the compressed image with fixed bit rate.

FIG. 2 illustrates a prior art image frame compression method which applies a lossless compression coding method 22 to reduce the data number of a segment of pixels 21 to a predetermined data rate. When the complexity of a segment of pixels is beyond a threshold, this segment of pixels can no longer be compressed with the selected lossless compression method, another method of a lossy compression algorithm 23 will be applied to compress the segment of pixels. For accelerating the speed of compressing the segment of pixels, both lossless compression and lossy compression methods are implemented to compress the coming segment of pixels and a multiplexer 24 selects one of the two outputs. In the lossy compression method, the two commonly used mechanisms are: truncation and DCT transfer. Truncating a certain length of bits of each pixel within a segment according to the targeted data rate or according to the accumulated data rate of a certain amount of segments, said a line or two line of pixels. In DCT transfer mechanism, it always combines quantization and a variable length, VLC coding.

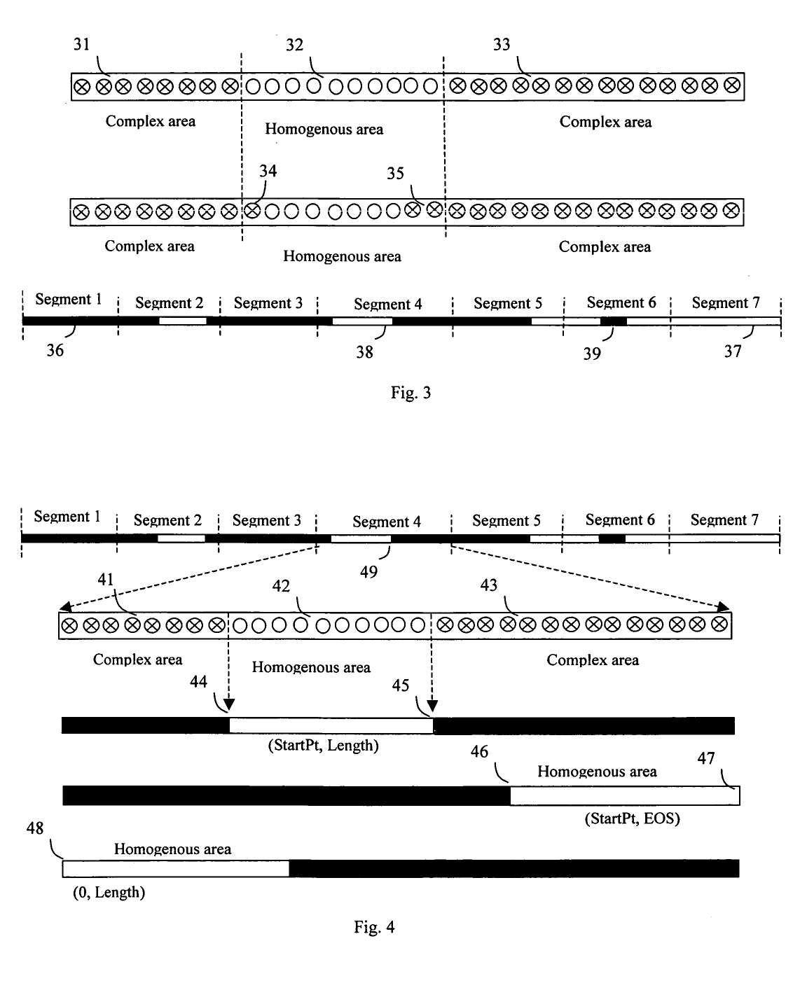

As shown in FIG. 3, both truncation and DCT transfer methods have similar disadvantage of causing more obvious artifact in the homogenous area 32 when a segment is comprised at least one homogenous area and complex areas 31, 33 since complex area causes more bit rate to represent. The DCT transfer will cause error during quantization which spread the error to neighboring pixels 34, 35 of the homogenous area. If truncation is selected, more pixels with artifact will become obvious. Error in the homogenous region is more obvious than that in the complex pattern. For instance, it's hard to tell the error of an error of 3 bits (ex. +/−7) in complex area, but is very obvious artifact in homogenous area. This invention compresses a group of pixels segment by segment with variable compression algorithms depending on the content of the segment. A segment comprising of pixels with mostly complex patterns (ex. Segment 7, 37) is very easy in compression with higher compression rate and good image quality. While, a segment might be comprised of pixels with mostly complex patterns (ex. Segment 1, 36 and segment 3) which have large differential values between adjacent pixels. It is hard to compress complex pattern with higher compression rate without sacrificing image quality. From the other hand, the complex area can be more tolerant to error than the homogenous area. If a complex pattern is sandwiched between two homogenous sections 39, and the complex area is not longer than the homogenous area, then, it is still easy to achieve high compression rate with good quality. A selected lossless compression algorithm can be applied to both above conditions. The most complicated condition easy to encounter obvious artifact is a homogenous area sandwiched between two complex sections 38 as show in segment 4.

Since a segment with more complex patterns 49 than homogenous area as show in FIG. 4, will have difficulty of compressing complex pattern which causes more bits which also results in over budget of the bit number by using only one lossless compression algorithm, then, truncation LSB bits of all pixels within a segment or switch to another algorithm of transfer function causes error in both complex and homogenous areas. This kind of worst case segment might be comprised of three conditions:

1. A homogenous area 42 is sandwiched between two complex patterns 41, 43.

2. A complex area followed a homogenous pattern.

3. A homogenous area followed a complex pattern.

This invention compresses a segment with most pixels of complex pattern by using a lossy algorithm which might include truncation or DCT transfer plus quantization and a VLC coding. A segment of most homogenous area can also be compressed by a selected lossless compression algorithm. This invention also identifies the homogenous and complex areas and separates them and applies different compression algorithms, might be one lossless compression algorithm for the homogenous area and another lossy algorithm for the complex area. Under this mixture mode of homogenous and complex areas, the starting point 44 of homogenous is marked by a predetermined length of bits and another predetermined length 45 of bits, for example, said 4 bits are used to identify the length of homogenous area. So, in the bit stream of the compressed segment, will there be a pair of starting point 46 and length of homogenous area, said (StartPoint, Length). For saving bits, if the homogenous area lasts till the end of segment, a shorter code, for example a “0” is assigned to represent “End of Segment”, EOS 47. Another case is the homogenous area starts from the beginning of a segment which could be an extension of homogenous area from previous segment and a shorter code, for example, said “0” can be assigned to represent the starting point is from “Begin of a segment” 48. Separating homogenous area from complex area can let homogenous area to be compressed by a lossless compression algorithm and saves bits for complex area. And should the saved amount of bits in the homogenous area is not enough for the complex area to reach lossless compression due to large amount of pixels in the complex area, lossless algorithm of LSB bit truncation or DCT transfer which cause error only in the complex area which will not contaminate the image quality of the homogenous area and still keeps this homogenous area a good image quality.

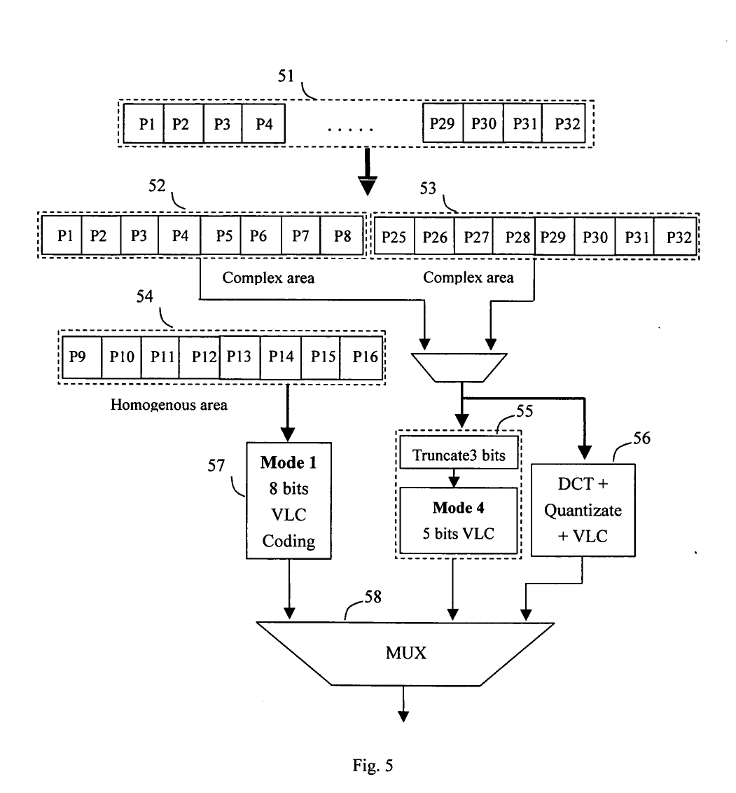

FIG. 5 summarizes this invention of compressing an image frame. A segment 51 is examined and partitioned into homogenous 54 and perhaps two sub-segments of complex areas 52, 53. The complex sub-segments are compressed by lossy algorithms which might be a truncation followed by a lossless compression 55 or a DCT+quantization+a VLC coding 56 whichever is shorter will be selected to be the output of this sub-segments. Another lossless compression 57 is applied to the sub-segment with homogenous area. A multiplexer, MUX 58 selects the output of a segment compression. A segment with simple pattern can easily be compressed by lossless compression algorithm, while the segment with very complex pattern will be compressed by a lossy compression algorithm.

The segment with partial homogenous area and partial complex pattern needs calculation to decide whether to separate the homogenous area from the complex area within one segment. The decision of separately compressing the homogenous and complex areas depends on the calculated image quality, the predicted accumulative bit rate till that corresponding segment.

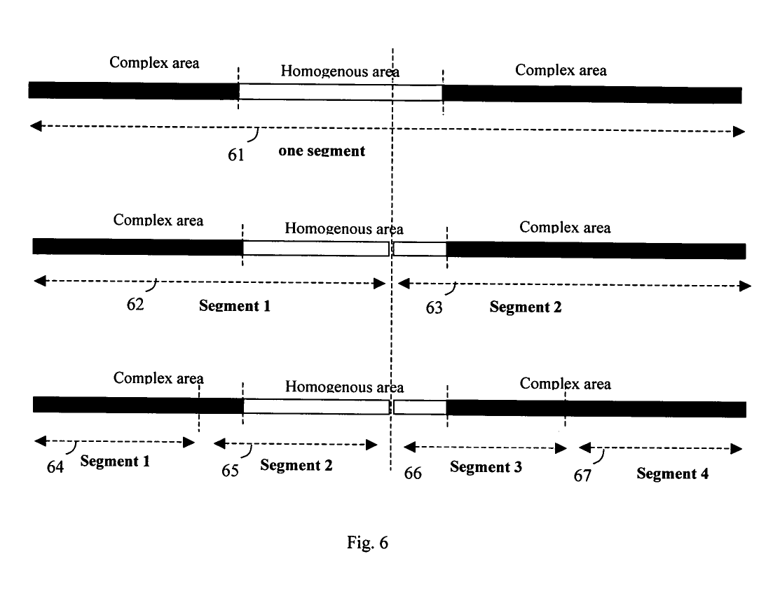

Another mechanism of applying only one compression algorithm into a segment or a sub-segment is optionally selected to avoid error happened into the homogenous area as shown in FIG. 6. A segment 61 comprising of a homogenous area and two complex sectors is partitioned into 2 “Sub-segments” 62, 63 and compress with both sub-segment having one homogenous area and one complex area and are compressed both by one compression algorithm which can be lossless if it works or lossy algorithm if a lossy algorithm does not meet the bit budget. In the example shown in FIG. 6, the right sub-segment has more pixels in the complex area, and more difficult in lossless compression, so, a lossly algorithm, said a truncation or DCT is applied which results error in the homogenous area. And the left sub-segment, has less pixels in the complex area, and a lossless compression algorithm might meet the bit budget and no error is generated in the homogenous area. Or should lossless compression is not possible, and lossy is not avoidable, truncating less bits might be feasible which reduces the image quality degradation. This mechanism of applying only one algorithm into one sub-segment can be extended to partition a segment into four or even eight sub-segments depending on the length of the segment. In this example shown in FIG. 6, a segment is partitioned into four sub-segments 64, 65, 66, 67 with sub-segment 1 and sub-segment 4 having all pixels falling into complex area and sub-segment 3 having most pixels falling into the homogenous area and can be easily compressed by a selected lossless algorithm. Another sub-segment is comprised of some pixels of homogenous area and followed by a more pixels in the complex area which will be compressed by a lossy algorithm and error in the homogenous area is not avoidable. In summary, this partitioning one longer segment into multiple shorter sub-segments helps reducing the probability of image degradation by reducing the segment size into smaller sub-segment. The thresholds of deciding a segment “simple” or “complex” in this invention is judged by examining the amount of pixels with differential value between adjacent pixel larger than a threshold, for example a value of 64 which will require longer than 8 bits to represent.

Most of this description of this invention is based on pixel has Y, U and V components. Actually, this method of invention applies to pixels with Red, Green and Blue component and other image composition. When compressing the segment of pixel components, the data rate of each segment can be fixed or can be variable from segment to segment by prediction.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of compressing an image frame, comprising:
partitioning an image frame of pixels into a predetermined amount of segments with each segment having a predetermined amount of pixels;
if the segment is a mixture of simple pattern and more pixels of complex patterns, then, separating the segment of pixel components into at least two areas and applying a lossless compression to code the area of simple pattern and applying a lossy compression algorithm to code the area of complex pattern; otherwise,
applying a lossless compression algorithm to code the segment of pixel components, if the code length is within budget, then, the result is selected to be the output, otherwise, applying a lossy compression algorithm to code the segment of pixel components and select the result of code to be the output.

2. The method of claim 1, wherein a predetermined length of code is applied to represent the starting location of homogenous area, and if the homogenous area starts from the beginning of a segment, a short code is assigned to represent “Begin of Segment”.

3. The method of claim 1, wherein another predetermined length of code is applied to represent the number of continuous pixels inside the homogenous area, and if the homogenous area extends to the end of a segment, a short code is assigned to represent “End of Segment”.

4. The method of claim 1, wherein if the segment has simple pattern, calculating the differential values between adjacent pixels with the segment and applying a variable length coding method to represent the values.

5. The method of claim 1, wherein if the segment has complex pattern, then, truncating at least 2 LSI bits, afterward, applying a lossless compression coding method to represent the truncated differential values of adjacent pixels.

6. The method of claim 1, wherein if the segment has complex pattern, then, transfer the segment of pixel components into frequency coefficients and quantizing them, afterward, applying a lossless compression coding method to represent the quantized coefficients.

7. The method of claim 1, wherein separating the homogenous area from the pixels with complex pattern by detecting the number of continuous low differential values of adjacent pixels with a predetermined threshold value.

8. The method of claim 1, wherein separating the homogenous area from complex area, and forwarding those pixel components in homogenous area to a lossless compression engine for data rate reduction, and those pixel components in complex area to a selected lossy compressor for data reduction.

9. The method of claim 8, wherein calculating the image quality of the segment of complex pattern which go through lossy compression methods and selecting the one with better quality to the output of that segment.

10. A method of compressing an image frame, comprising:
partitioning an image frame of pixels into a predetermined amount of segments with each segment having a predetermined amount of pixels;
determining the data rate and applying a lossless compression algorithm to code the segment of pixel components with simple pattern;
determining the data rate and applying a lossy compression algorithm to code the segment of pixel components with complex pattern; and
if the segment is a mixture of simple pattern and more pixels of complex patterns, then, dividing the segment of pixel components into at least two sub-segments and applying a lossless compression to code the sub-segment of simple pixel pattern and applying a lossy compression algorithm to code the sub-segment of complex pattern.

11. The method of claim 10, wherein the sub-block with high complexity will go through lossy compression algorithm by truncating 1 to 3 LSI bit and taking the differential values of adjacent pixels, then applying a lossless compression algorithm to represent the truncated pixel components.

12. The method of claim 10, wherein the sub-block with still mixture of homogenous area and complex area, if the percentage of the homogenous area is larger than a predetermined threshold, then, applying a lossless compression algorithm to code that sub-segment.

13. The method of claim 10, wherein the sub-block with still mixture of homogenous area and complex area, if the percentage of the homogenous area is smaller than a predetermined threshold, then, applying a lossy compression algorithm to code that sub-segment.

14. The method of claim 10, wherein the sub-block a segment with mixture of homogenous area and complex area is partitioned into four sub-segment with each sub-segment having the same amount of pixel components.
